(19) United States
(12) Patent Application Publication
(10) Pub. No.: US 2026/0333433 A1
(43) Pub. Date: Oct. 22, 2026

(54) PERFORMING NON-PRIMARY CHANNEL ACCESS (NPCA) OPERATIONS WITHOUT INTERFERING WITH COORDINATED TIME DIVISION MULTIPLE ACCESS (CO-TDMA) OPERATIONS

(71) Applicant: NEWRACOM, Inc., Irvine, CA (US)

(72) Inventors: Si-Chan NOH, Seoul (KR); Joonsoo LEE, Irvine, CA (US)

(73) Assignee: NEWRACOM, Inc., Irvine, CA (US)

(21) Appl. No.: 19/643,670

(22) Filed: Apr. 9, 2026

Related U.S. Application Data
(60) Provisional application No. 63/792,086, filed on Apr. 21, 2025.

(51) Int. Cl. H04W 74/0816; H04W 72/0446; H04W 88/08

(52) U.S. Cl. CPC H04W 74/0816; H04W 72/0446; H04W 88/08

(57) ABSTRACT

An embodiment is a method performed by a first access point (AP) operating a first basic service set (BSS) to perform non-primary channel access (NPCA) operations without interfering with coordinated time division multiple access (Co-TDMA) operations. The method includes sharing a transmission opportunity (TXOP) owned by the first AP with a second AP in a Co-TDMA shared AP channel, wherein the second AP operates a second BSS that is different from the first BSS and performing NPCA in a NPCA available channel of the first BSS in response to detecting an overlapping basic service set (OBSS) transmission and determining/confirming that the NPCA available channel does not overlap with the Co-TDMA shared AP channel.

### CROSS-REFERENCE TO RELATED APPLICATION

This application claims the benefit of U.S. Provisional Application No. 63/792,086, filed Apr. 21, 2025, titled “Interoperation between M-AP schemes and subband operations”, which is hereby incorporated by reference.

### TECHNICAL FIELD

The present disclosure generally relates to wireless communications, and more specifically, relates to performing non-primary channel access (NPCA) operations without interfering with coordinated time division multiple access (Co-TDMA) operations.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHz, 6 GHz, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

According to existing IEEE 802.11 wireless networking standards, before a wireless device can transmit a physical layer protocol data unit (PPDU), the wireless device has to verify that the transmission bandwidth, including the primary channel, is idle. For example, consider a station (STA) having an operating bandwidth (OPBW) of 80 MHz. The 80 MHz operating bandwidth may include a primary 20 MHz (P20) channel, a secondary 20 MHz (S20) channel, and a secondary 40 MHz (S40) channel. To transmit a 40 MHz PPDU, both the P20 and S20 channels within the 80 MHz operating bandwidth have to be idle. In a scenario where the P20 channel is busy but the S40 is idle, the STA is not allowed to transmit a 40 MHz PPDU in the S40 channel (even though it is idle) due to an existing rule that transmission is not allowed when the primary channel is busy.

In IEEE 802.11bn (also referred to as ultra high reliability (or “UHR”)), with the increase in the operating bandwidth (e.g., to 320 MHz), the traditional rule that prevents PPDU transmission when the primary channel is busy and the secondary channel is idle (e.g., P20 channel is busy and secondary 160 MHz (S160) channel is idle) is seen as inefficient and wasteful of resources. The concept of non-primary channel access (NPCA) has been proposed to address this issue. With NPCA, transmission and reception can be performed in an idle non-primary channel (e.g., a secondary channel) even if the primary channel is busy. That is, even if the primary channel is busy, if there is a non-primary channel that is idle, NPCA allows transmission/reception in the idle non-primary channel.

Coordinated time division multiple access (Co-TDMA, C-TDMA, c-TDMA, or cTDMA) is a multi-AP coordination scheme that allows an access point (AP) to share its transmission opportunity (TXOP) with other AP(s). For example, with Co-TDMA, a first AP that owns a TXOP may share a portion of the TXOP with a second AP. The second AP may then transmit and receive in its basic service set (BSS) during its allocated portion of the TXOP. Stated differently, the first AP may allocate a portion of the TXOP to the second AP to allow the second AP to transmit and receive with its associated non-AP stations (STAs) during the allocated portion of the TXOP even though the second AP is not the original TXOP owner. If the second AP finishes transmission and reception before its allocated portion of the TXOP expires, the second AP may be allowed to return the TXOP to the first AP so that the first AP can resume the TXOP. In such a TXOP sharing scenario, the first AP may be referred to as the sharing AP and the second AP may be referred to as the shared AP.

When NPCA operations are performed in conjunction with co-TDMA operations, the NPCA operations can interfere with the Co-TDMA operations by causing channel overlap (e.g., the channel used for NPCA (e.g., NPCA primary channel) may overlap with the channel used for Co-TDMA).

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing the overcall concept of non-primary channel access (NPCA), according to some embodiments.

FIG. 11 is a diagram showing a coordinated time division multiple access (Co-TDMA) scenario where transmission opportunity (TXOP) return is not allowed and the shared access point (AP) uses all of its allocated portion of the TXOP, according to some embodiments.

FIG. 12 is a diagram showing a Co-TDMA scenario where TXOP return is allowed and the sharing AP resumes the TXOP after receiving a TXOP return frame from the shared AP, according to some embodiments.

FIG. 13 is a diagram showing a duration/ID field included in the multi-user request-to-send TXOP sharing (MU-RTS TXS) frame being set to the sum of a clear-to-send (CTS) frame transmission duration and one SIFS interval duration, according to some embodiments.

FIG. 14 is a diagram showing a wireless network in which NPCA operations and Co-TDMA operations can be performed in conjunction when an overlapping basic service set (OBSS) transmission triggers NPCA, according to some embodiments.

FIG. 15 is a diagram showing how the sharing AP's NPCA operations can interfere with the shared AP's Co-TDMA operations, according to some embodiments.

FIG. 16 is a diagram showing how the sharing AP's NPCA operations can end later than shared AP's Co-TDMA operations, according to some embodiments.

FIG. 17 is a diagram showing a wireless network in which NPCA operations and Co-TDMA operations can be performed in conjunction and when the shared AP's in-BSS (in-basic service set) transmission triggers NPCA, according to some embodiments.

FIG. 18 is a diagram showing how the sharing AP's NPCA operations can interfere with the shared AP's in-BSS TXOP sharing, according to some embodiments.

FIG. 19 is a diagram showing how NPCA can be performed when the NPCA available channel does not overlap with the Co-TDMA shared AP channel, according to some embodiments.

FIG. 20 is a diagram showing how the NPCA operation duration can be adjusted so that the NPCA operation period ends before the TXOP allocation period ends, according to some embodiments.

FIG. 21 is a flow diagram of a method for performing NPCA operations without interfering with Co-TDMA operations, according to some embodiments.

FIG. 22 is a flow diagram of a method for configuring a NPCA operation duration, according to some embodiments.

FIG. 23 is a flow diagram of a method for determining whether to perform NPCA channel switching, according to some embodiments.

### DETAILED DESCRIPTION

The present disclosure generally relates to wireless communications, and more specifically, relates to performing non-primary channel access (NPCA) operations without interfering with coordinated time division multiple access (Co-TDMA) operations.

As mentioned earlier, NPCA operations can interfere with Co-TDMA operations by causing channel overlap (e.g., the channel used for NPCA (e.g., NPCA primary channel) may overlap with the channel used for Co-TDMA).

An interference avoidance technique is described herein that can prevent NPCA operations from interfering with Co-TDMA operations by ensuring there is no channel overlap. Also, the interference avoidance technique can adjust the NPCA operation duration so that NPCA operation period ends before the transmission opportunity (TXOP) allocated to the shared access point (AP) via Co-TDMA ends to enable seamless transition back to the primary channel. The interference avoidance technique can help ensure that non-AP (non-access point) STAs that are in a hidden relationship with shared AP(s) only perform NPCA when it is appropriate. The interference avoidance technique can use initial control frames to control the NPCA operation duration and ensure synchronization with TXOP allocation. The interference avoidance technique can help avoid unnecessary NPCA operations based on observing multi-user request-to-send transmission opportunity (MU-RTS TXS) frame and clear-to-send (CTS) frame exchange timings.

According to some embodiments, a first AP operating a first basic service set (BSS) shares a TXOP owned by the first AP with a second AP in a Co-TDMA shared AP channel, where the second AP operates a second BSS that is different from the first BSS. The first AP may then perform NPCA in a NPCA available channel in response to detecting an overlapping basic service set (OBSS) transmission and determining that a NPCA available channel of the first BSS does not overlap with the Co-TDMA shared AP channel.

According to some embodiments, after a STA belonging to a BSS operated by an AP has overheard a TXOP sharing frame transmitted by the AP to another AP, the STA may determine whether the AP transmitted a subsequent frame within a predefined period of time after transmitting the TXOP sharing frame and perform NPCA in a NPCA available channel of the BSS in response to detecting an OBSS transmission and determining that the AP has not transmitted the subsequent frame within the predefined period of time.

Embodiments can ensure that NPCA operations do not interfere with Co-TDMA operations, which can prevent unnecessary performance degradations and delays, thereby improving overall network efficiency and resource utilization.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

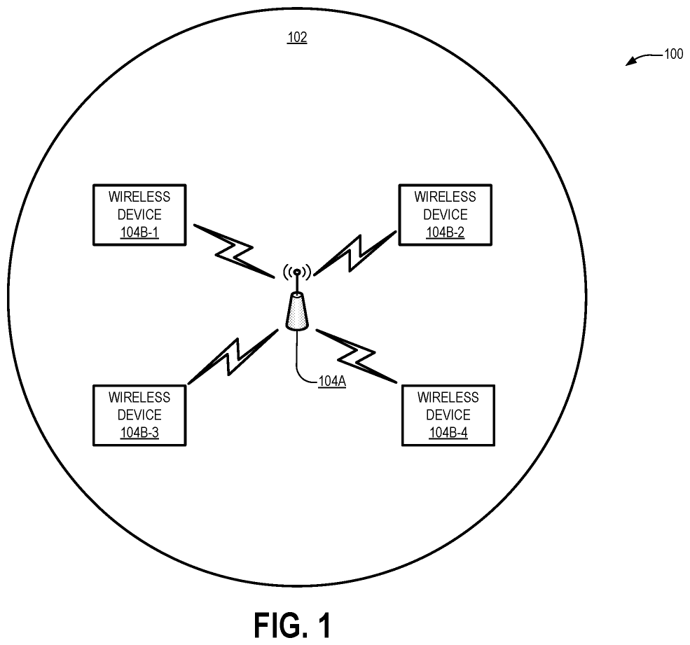

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART. request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

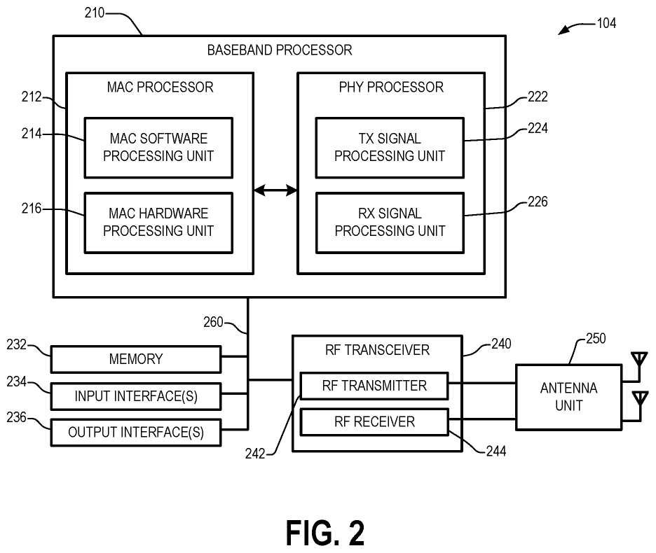

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

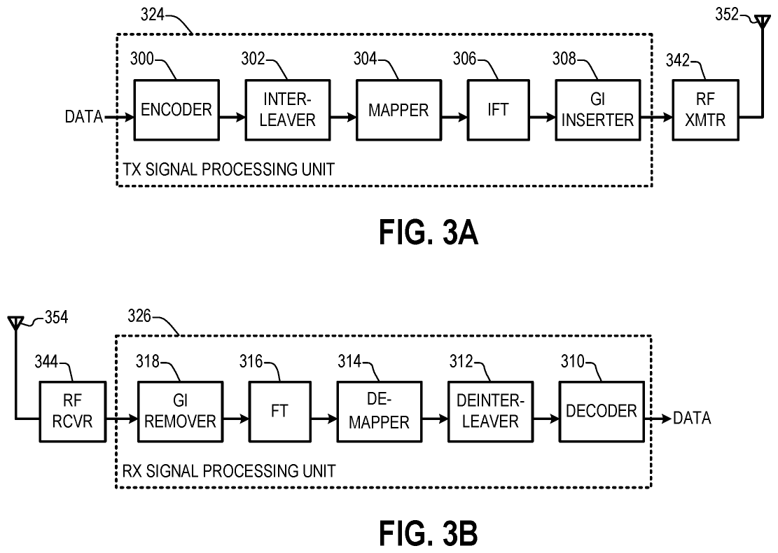

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160 +160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

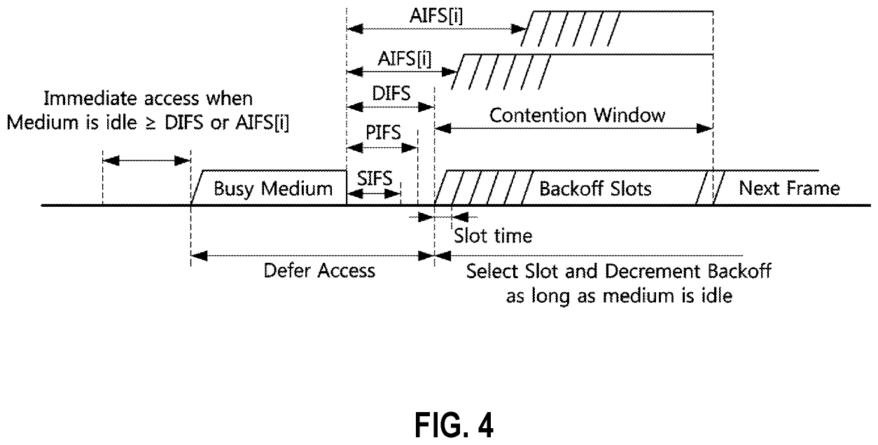

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

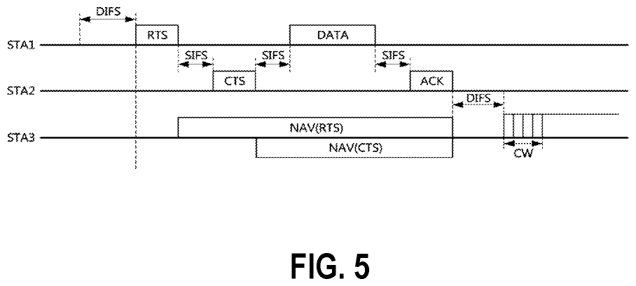

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

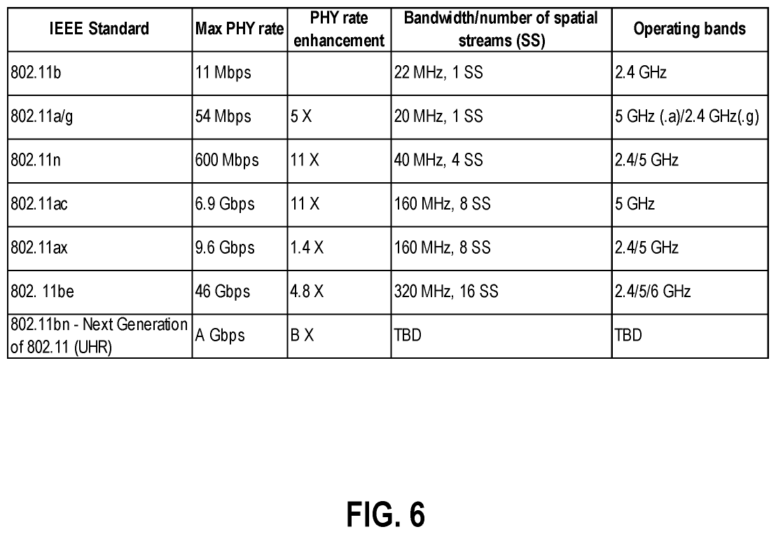

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925-7.125 GHz) is being considered for unlicensed use. This would allow APs and STAs to become tri-band devices. Larger than 160 MHz data transmissions (e.g., 320 MHz or 640 MHz) could be considered to increase the maximum PHY rate. For example, 320 MHz or 160+160MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

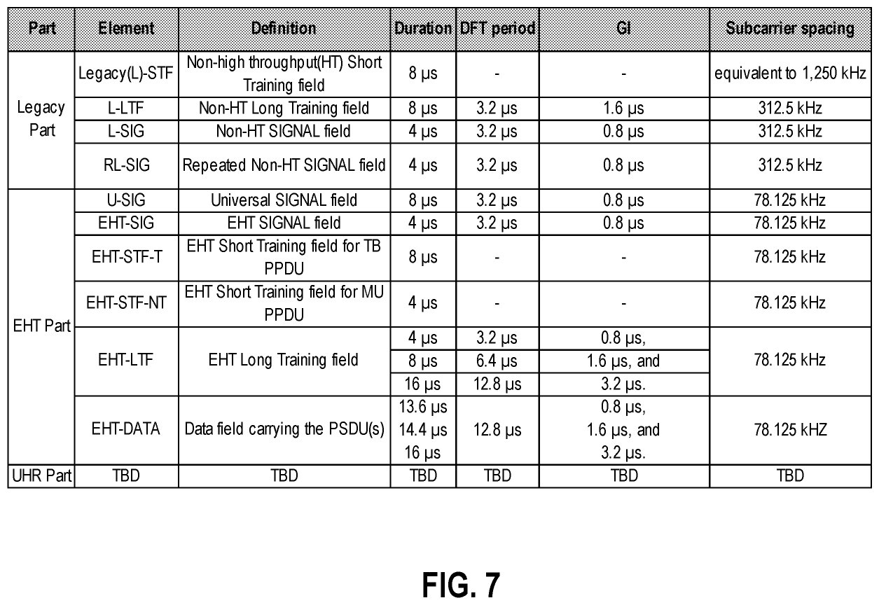

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

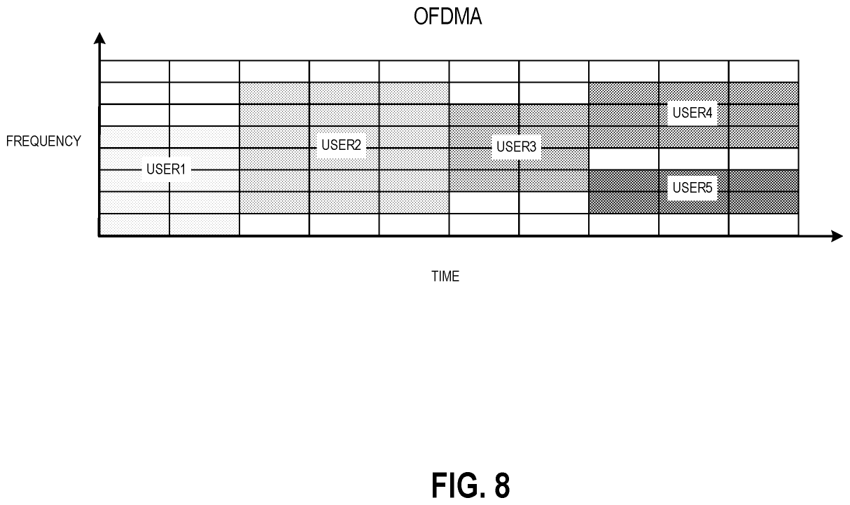

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

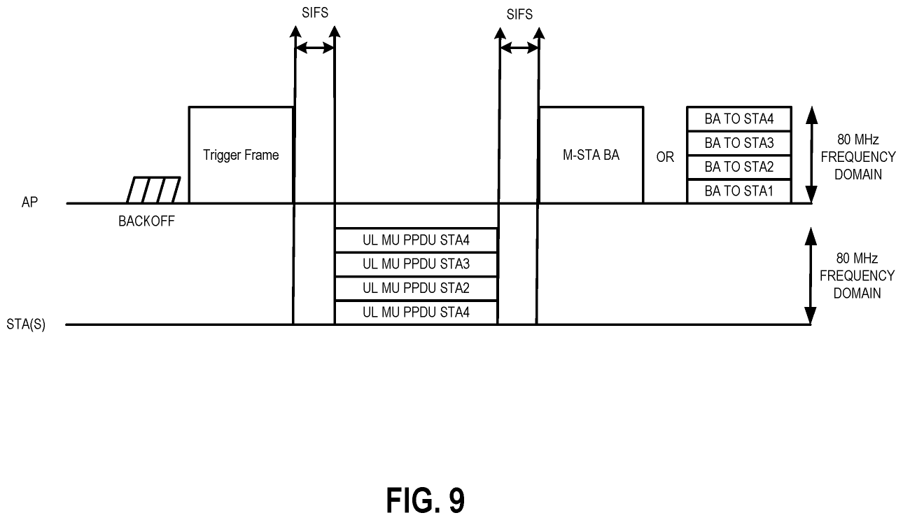

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (Co-TDMA or c-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (Co-BF): Multiple APs transmit on the same frequency resource by coordinating and forming spatial nulls, allowing for simultaneous transmission from multiple APs.

Coordinated OFDMA (Co-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (Co-SR): Multiple APs or STAs adjust their transmit power to reduce interference between APs.

By implementing these AP coordination schemes, WLAN systems can improve their overall throughput and efficiency by leveraging the cooperation between multiple APs.

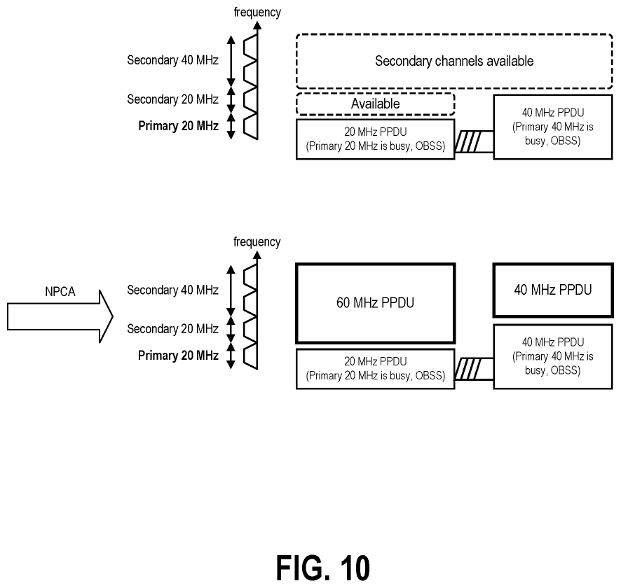

FIG. 10 is a diagram showing the overcall concept of NPCA, according to some embodiments.

The diagram shows the overall concept of NPCA when the operating bandwidth is 80 MHz. It should be appreciated, however, that NPCA is not limited to being used with an 80 MHz operating bandwidth but can be used with other operating bandwidth sizes. The 80 MHz operating bandwidth may include a primary 20 MHz (P20) channel, a secondary 20 MHz (P20) channel, and a secondary 40 MHz (S40) channel. As shown in the diagram, when a 20 MHz PPDU is transmitted in the P20 channel, the S20 channel and the S40 channel may be available. Also, when a 40 MHz PPDU is transmitted in the P40 channel, the S40 channel may be available. Traditional IEEE 802.11 wireless networks have a rule that does not allow transmission in non-primary channels (e.g., secondary channels) when the primary channel (e.g., the P20 channel) is busy even if the non-primary channels are idle.

In IEEE 802.11bn (also referred to as ultra high reliability (or “UHR”)), with the increase in the operating bandwidth (e.g., to 320 MHz), the traditional rule that prevents PPDU transmission when the primary channel is busy and the secondary channel is idle (e.g., P20 channel is busy and secondary 160 MHz (S160) channel is idle) is seen as inefficient and wasteful of resources. The concept of non-primary channel access (NPCA) has been proposed to address this issue. With NPCA, transmission and reception can be performed in an idle non-primary channel (e.g., a secondary channel) even if the primary channel is busy. That is, even if the primary channel is busy, if there is a non-primary channel that is idle, NPCA allows transmission/reception in the idle non-primary channel.

With NPCA, even if the primary channel is busy due to OBSS signals, transmission and reception may be allowed in a non-primary channel if certain conditions are met (e.g., clear channel assessment (CCA) indicates that the non-primary channel is idle). For example, as shown in the diagram, a 60 MHz PPDU may be transmitted in the S20 channel and S40 channel while a 20 MHz OBSS PPDU is being transmitted in the P20 channel. As another example, a 40 MHz PPDU may be transmitted in the S40 channel while a 40 MHz OBSS PPDU is being transmitted in the P20 channel and the S20 channel. By making use of otherwise unused non-primary channels, NPCA may improve channel utilization and thus improve the overall throughput in the wireless network.

Various terminology that will be used herein are now introduced.

As used herein, NPCA AP/STAs or NPCA-capable AP/STAs may refer to AP/STAs that are capable of performing NPCA.

As used herein, NPCA available channel may refer to a channel that can be used for NPCA operations.

As used herein, NPCA primary channel may refer to a subchannel (e.g., a 20 MHz (sub)channel) of the NPCA available channel that is used for performing backoff for NPCA operation. The NPCA primary channel may perform a similar role to the primary channel that APs/STAs use during normal (non-NPCA) operations.

As used herein, MyBSS primary channel may refer to the primary channel of MyBSS/BSS.

As used herein, NPCA channel switching may refer to the act of switching from operating in the MyBSS primary channel to operating in the NPCA primary channel for NPCA operations.

As used herein, NPCA duration or NPCA operation duration may refer to the duration during which NPCA operations can be performed.

Coordinated time division multiple access (Co-TDMA, C-TDMA, cTDMA, or c-TDMA) is a multi-AP coordination scheme that allows an AP to share its TXOP with other AP(s). For example, with Co-TDMA, a first AP that owns a TXOP may share a portion of the TXOP with a second AP. The second AP may then transmit and receive in its BSS during its allocated portion of the TXOP. Stated differently, the first AP may allocate a portion of the TXOP to the second AP to allow the second AP to transmit and receive with its associated non-AP stations (STAs) during the allocated portion of the TXOP even though the second AP is not the original TXOP owner. In such a TXOP sharing scenario, the first AP may be referred to as the sharing AP and the second AP may be referred to as the shared AP.

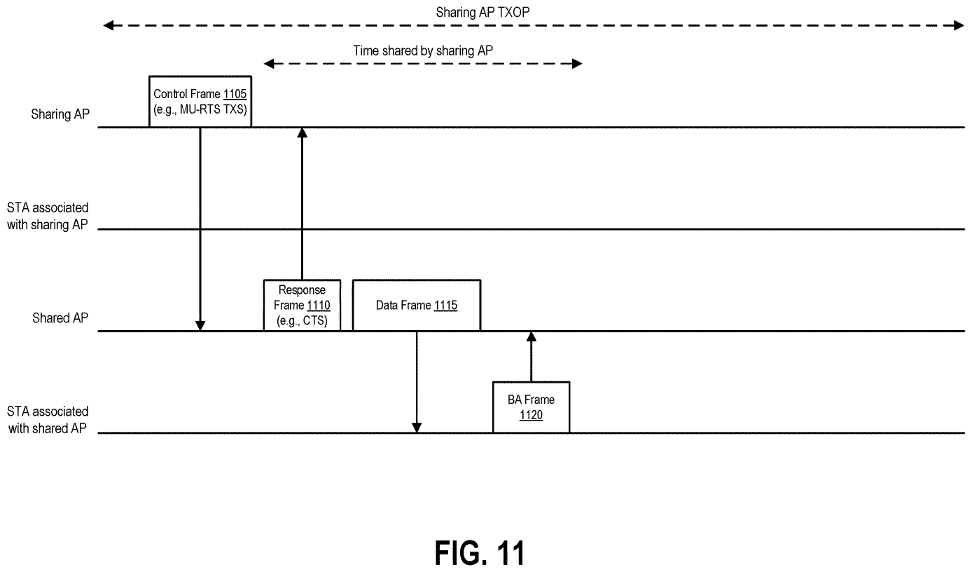

In a Co-TDMA scenario, TXOP return may be allowed or not allowed. The sharing AP may indicate in advance whether TXOP return is allowed when allocating a portion of the TXOP to the shared AP. In this context, “return” refers to a shared AP returning the remaining portion of its allocated portion of TXOP back to the sharing AP if the shared AP will not use the remaining portion. The indication of whether TXOP return is allowed can be communicated through prior signaling between the sharing AP and shared AP or through a MU-RTS TXS frame that initiates the TXOP sharing (e.g., control frame 1105 shown in FIG. 11). If the sharing AP indicates that TXOP return is allowed, the shared AP may return the remaining portion of its allocated portion of the TXOP back to the sharing AP before the TXOP expires. If TXOP return is not allowed, the shared AP may either use its allocated portion of the TXOP until it expires or the channel can be in a fair contention-based state (i.e., contention-free) allowing other STAs to access the channel for transmission.

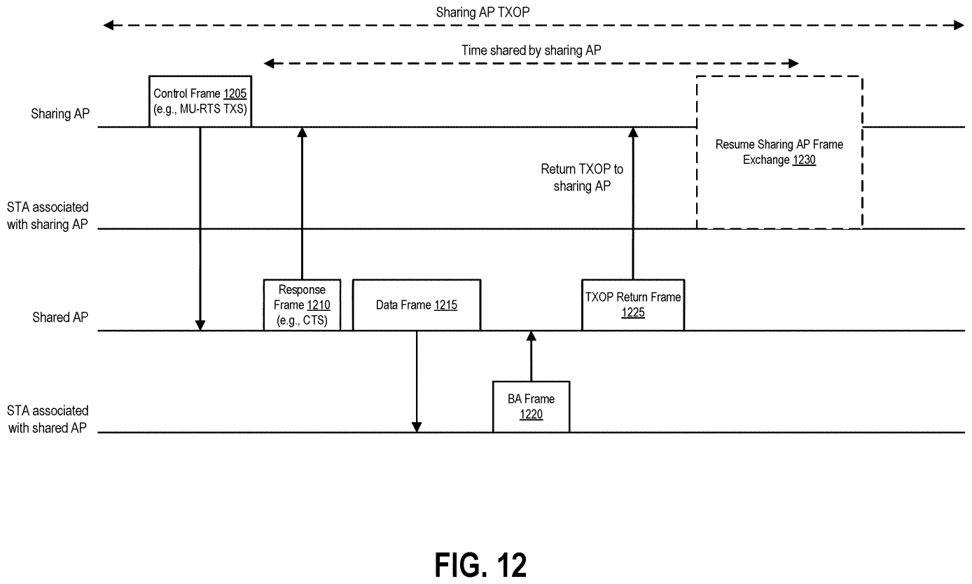

FIG. 11 shows a Co-TDMA scenario where TXOP return is not allowed and FIG. 12 shows a Co-TDMA scenario where TXOP return is allowed.

FIG. 11 is a diagram showing a Co-TDMA scenario where TXOP return is not allowed and the shared AP uses all of its allocated portion of the TXOP, according to some embodiments.

As shown in the diagram, the sharing AP may transmit control frame 1105 to the shared AP to indicate to the shared AP that the sharing AP is allocating a portion of the sharing AP's TXOP to the shared AP. In an embodiment, control frame 1105 is a multi-user request-to-send TXOP sharing (MU-RTS TXS) frame. Responsive to receiving control frame 1105, the shared AP may transmit response frame 1110 to the sharing AP. In an embodiment, response frame 1110 is a CTS frame. During the portion of the sharing AP's TXOP allocated to the shared AP (depicted as “Time shared by sharing AP” in the diagram), the shared AP may transmit data frame 1115 to a STA that is associated with the shared AP. If the STA successfully receives data frame 1115, the STA may transmit block acknowledgement (BA) frame 1120 to the shared AP. The sharing AP may resume its TXOP (e.g., resume transmission and reception with its associated non-AP STAs) after the portion of the TXOP allocated to the shared AP expires.

FIG. 12 is a diagram showing a Co-TDMA scenario where TXOP return is allowed and the sharing AP resumes the TXOP after receiving a TXOP return frame from the shared AP, according to some embodiments.

The diagram illustrates a Co-TDMA scenario where the sharing AP allocates a portion of its TXOP to the shared AP and allows the TXOP to be returned. If the shared AP completes its transmission and reception before the allocated portion of the TXOP expires, the shared AP may return the TXOP to the sharing AP, which allows the sharing AP to resume the TXOP and continue transmission and reception with its associated non-AP STAs.

As shown in the diagram, the sharing AP may transmit control frame 1205 (e.g., MU-RTS TXS frame) to the shared AP to indicate to the shared AP that the sharing AP is allocating a portion of the sharing AP's TXOP to the shared AP. Responsive to receiving control frame 1205, the shared AP may transmit response frame 1210 (e.g., CTS frame) to the sharing AP. During the portion of the sharing AP's TXOP allocated to the shared AP (depicted as “Time shared by sharing AP” in the diagram), the shared AP may transmit data frame 1215 to a STA that is associated with the shared AP. If the STA successfully receives data frame 1215, the STA may transmit BA frame 1220 to the shared AP. If the shared AP finishes transmission reception in its BSS before its allocated portion of the TXOP expires, the shared AP may transmit TXOP return frame 1225 to the sharing AP to return the TXOP to the sharing AP. Upon receiving TXOP return frame 1225, the sharing AP may resume the TXOP. For example, the sharing AP may perform frame exchange 1230 in its own BSS with its associated non-AP STAs.

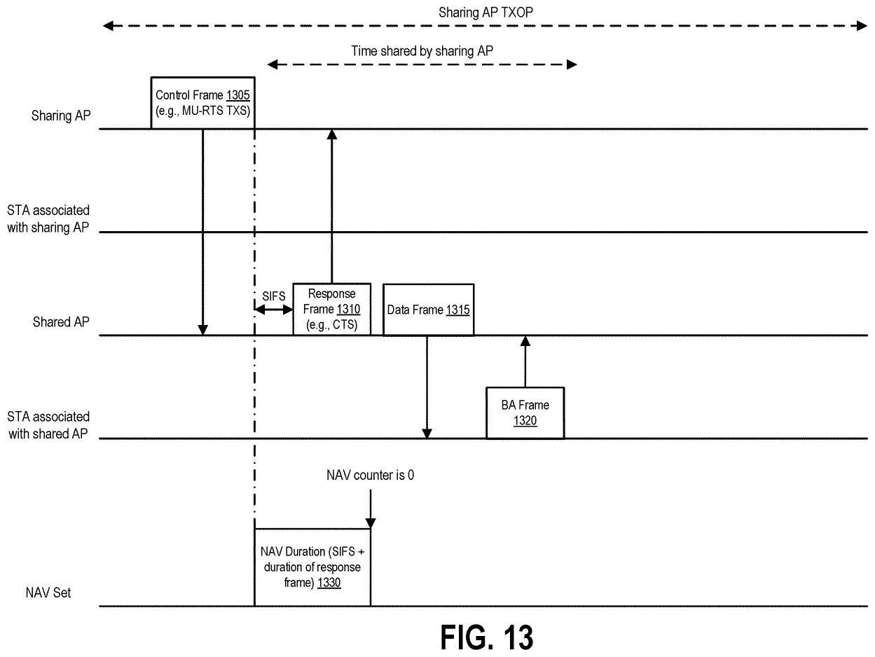

FIG. 13 is a diagram showing a duration/ID field included in the MU-RTS TXS frame being set to the sum of a CTS frame transmission duration and one SIFS interval duration, according to some embodiments.

The diagram illustrates the NAV duration in a Co-TDMA scenario where the sharing AP allocates a portion of its TXOP to the shared AP using a control frame exchange (e.g., MU-RTS TXS frame and CTS frame exchange).

As shown in the diagram, the sharing AP may transmit control frame 1305 (e.g., MU-RTS TXS frame) to the shared AP to indicate to the shared AP that the sharing AP is allocating a portion of the sharing AP's TXOP to the shared AP. Responsive to receiving control frame 1305, the shared AP may transmit response frame 1310 (e.g., CTS frame) to the sharing AP after a short interframe space (SIFS) interval after receiving control frame 1305. During the portion of the sharing AP's TXOP allocated to the shared AP (depicted as “Time shared by sharing AP” in the diagram), the shared AP may transmit data frame 1315 to a STA that is associated with the shared AP. If the STA successfully receives data frame 1315, the STA may transmit BA frame 1320 to the shared AP.

Control frame 1305 may set a NAV duration 1330 that corresponds to the sum of the transmission duration of response frame 1310 and a SIFS interval duration. For example, if control frame 1305 is a MU-RTS TXS frame and response frame 1310 is a CTS frame, the duration/ID field included in the MU-RTS TXS frame may be set to indicate the duration required to transmit the CTS frame plus the duration of one SIFS interval.

In the scenarios shown in FIGS. 11-13, the sharing AP is depicted as transmitting the MU-RTS TXS frame (e.g., control frame 1105) in the middle of its TXOP instead of at the beginning of its TXOP. The reason for this is that, prior to transmitting the MU-RTS TXS frame to share its TXOP, the sharing AP may perform frame exchanges with non-AP STAs associated with the sharing AP and/or perform frame exchanges with the shared AP to exchange information (e.g., bandwidth, capability, etc.).

The present disclosure describes solutions that can address problems that can arise when NPCA operations are performed in conjunction with Co-TDMA operations. NPCA is a technology that enables communication via an available non-primary/secondary channel when the primary channel of a given BSS (MyBSS) is occupied by OBSS transmissions. Co-TDMA is a technology that enables a sharing AP to allocate a portion of its acquired TXOP to a shared AP to allow the shared AP to transmit and receive in the shared AP's BSS during the portion allocated to it. However, when NPCA-capable AP/STAs, including the sharing AP and its associated STAs, initiate NPCA operations during a Co-TDMA procedure, various problems can arise.

Before describing the problems in detail, an example network topology in which the problems can arise is described to provide context and aid understanding. For explanation purposes only, various embodiments will be described in the context of this example network topology shown in the diagram. However, it will be appreciated that the problems mentioned herein can arise in wireless networks having different network topologies than the one shown in the diagram. Also, the interference avoidance techniques described herein may be applicable to those wireless networks.

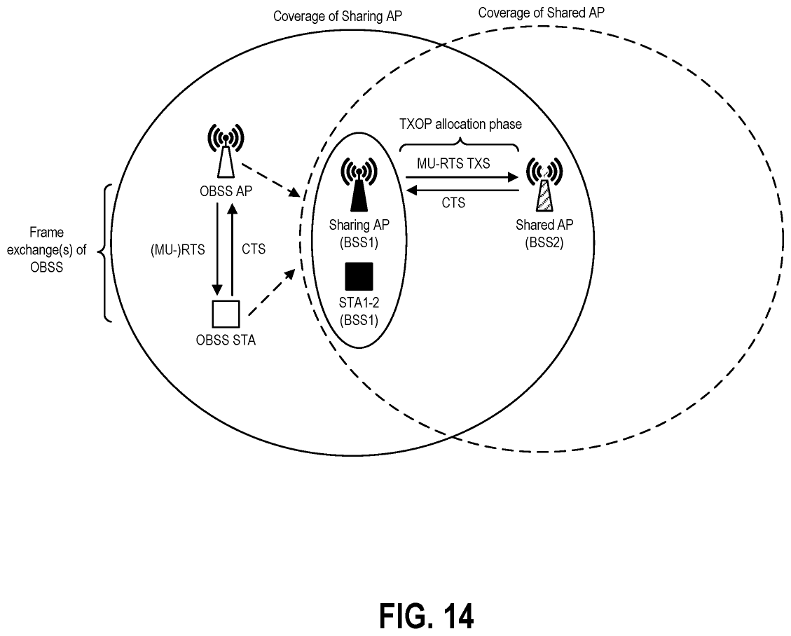

FIG. 14 is a diagram showing a wireless network in which NPCA operations and Co-TDMA operations can be performed in conjunction when an OBSS transmission triggers NPCA, according to some embodiments.

As shown in the diagram, the wireless network includes a sharing AP operating a first BSS (BSS1), a shared AP operating a second BSS (BSS2), and an OBSS AP operating an OBSS. BSS1 may include the following STA: STA1-2. OBSS may include an OBSS STA. In this example, it is assumed that the sharing AP and STA1-2 are capable of performing NPCA. Also, it is assumed that the sharing AP and the shared AP operate in the same primary channel. The coverage (transmission range) of the sharing AP is shown in a solid line and the coverage (transmission range) of the shared AP is shown in a dashed line.

To initiate Co-TDMA, the sharing AP and shared AP may perform a TXOP allocation phase via a control frame exchange. For example, as shown in the diagram, the sharing AP may transmit a MU-RTS TXS frame to the shared AP to allocate a portion of its TXOP to the shared AP and the shared AP may confirm this by transmitting a CTS frame to the sharing AP. The bandwidth or channel available to the shared AP during its allocated portion of the TXOP (e.g., which may be the overlapping portion of the bandwidths/channels in which the MU-RTS TXS frame and CTS frame were transmitted) may be referred to herein as the Co-TDMA shared AP bandwidth/channel.

Suppose the OBSS AP and the OBSS STA exchange (MU-)RTS/CTS frames with each other, which is overheard by the sharing AP and STA1-2. If this frame exchange satisfies the conditions for triggering NPCA operations (NPCA triggering conditions), the sharing AP and STA1-2 may perform NPCA channel switching (switch from operating in the primary channel of BSS1 to operating in the NPCA primary channel of BSS1) to perform NPCA.

A first problem (referred to herein as Problem 1 herein) that may arise in such a scenario is that when the sharing AP and STA1-2 perform NPCA in the NPCA primary channel, it may interfere with the shared AP's operation. In particular, interference may occur if the NPCA available channel (which includes the NPCA primary channel) overlaps with the Co-TDMA shared AP channel (the channel in which the shared AP performs Co-TDMA).

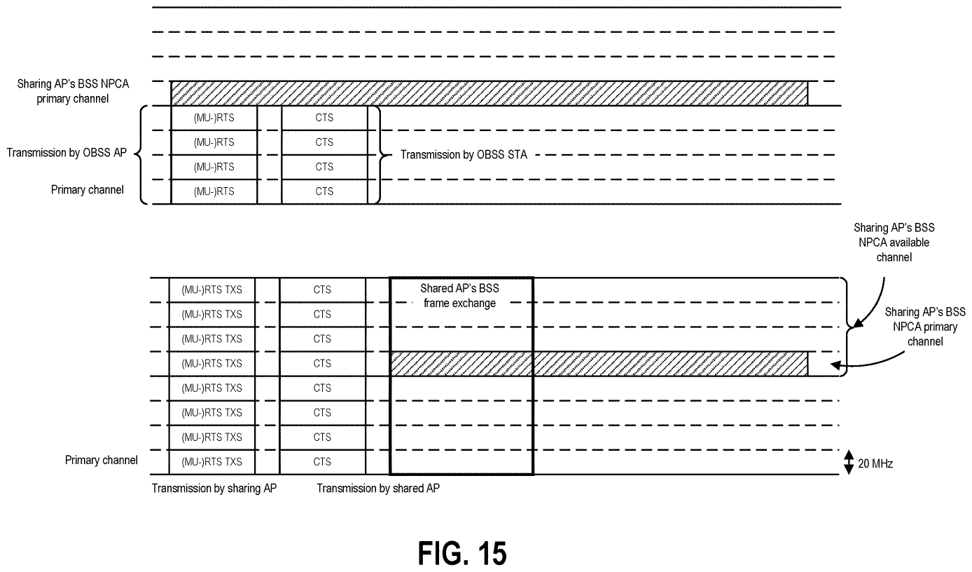

FIG. 15 is a diagram showing how the sharing AP's NPCA operations can interfere with the shared AP's Co-TDMA operations, according to some embodiments.

In the example shown in the diagram, it is assumed that the sharing AP transmits a 160 MHz (MU-)RTS TXS frame to the shared AP and the shared AP responds by transmitting a 160 MHz CTS frame to the sharing AP using a non-HT PPDU format. In this case, the shared AP's usable bandwidth for Co-TDMA operation (i.e., the Co-TDMA shared AP bandwidth) is 160 MHz. At the same time, if the sharing AP and STA1-2 switch from operating in the primary channel to operating in the NPCA primary channel based on overhearing an OBSS control frame exchange (e.g., (MU-)RTS frame and CTS frame exchange between OBSS AP and OBSS STA) and successfully perform backoff, they may gain access to the 80 MHz NPCA available channel (S80 channel) based on point coordination function (PCF) interframe space (PIFS) idleness detection. As a result, the sharing AP's NPCA operations may interfere with the shared AP's Co-TDMA operations due to the overlap of the NPCA available channel and the Co-TDMA shared AP channel. Thus, the shared AP may not be able to fully utilize the Co-TDMA shared AP bandwidth during its allocated portion of the TXOP. Further, consider the case where the shared AP performs in-BSS TXOP sharing (e.g., IEEE 802.11be TXOP sharing) to allocate a portion of its TXOP to its in-BSS STAs. If these STAs and the NPCA-capable AP/STAs (the sharing AP and STA1-2 in this example) are hidden from each other, overlapping transmissions may prevent the shared AP from being able to decode frames transmitted by its own in-BSS STAs (e.g., TXOP return frames).

A second problem (referred to as Problem 2 herein) that can arise in a scenario where NPCA operations are performed in conjunction with Co-TDMA operations is that the NPCA operations may affect the sharing AP's own ability to resume transmission after the portion of the TXOP allocated to the shared AP is over. For example, assume that the NPCA available channel does not overlap with the Co-TDMA shared AP channel, and that NPCA and Co-TDMA operations are performed concurrently. The NPCA operation duration of the NPCA triggered by the OBSS (MU-)RTS/CTS frame exchange may be longer than the duration allocated to the shared AP for Co-TDMA. In this case, the sharing AP and its associated STAs may return back to operating in the primary channel after the portion of the TXOP allocated to the shared AP has ended, making it impossible for the sharing AP to resume its TXOP via a TXOP return.

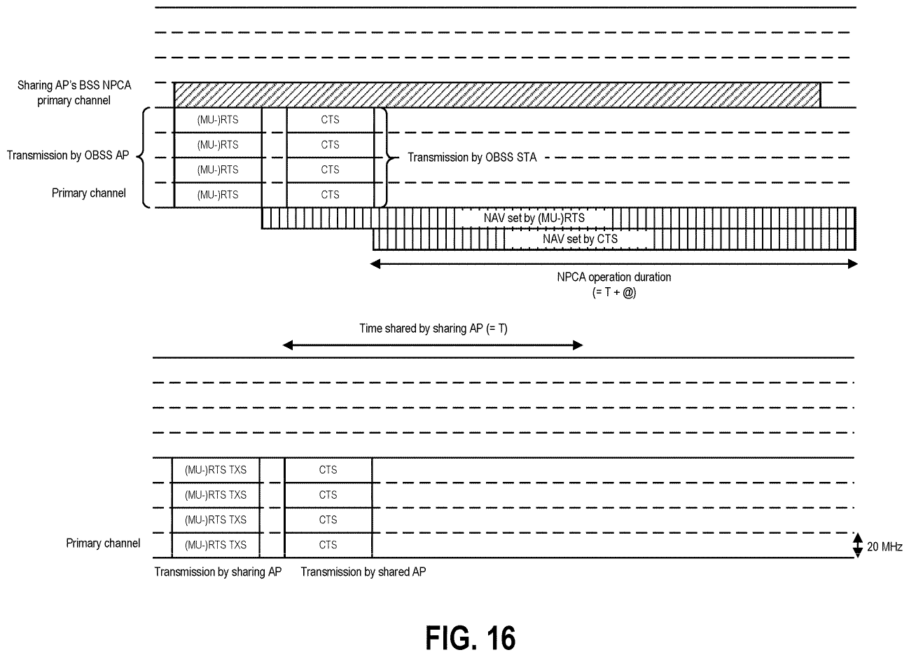

FIG. 16 is a diagram showing how the sharing AP's NPCA operations can end later than shared AP's Co-TDMA operations, according to some embodiments.

As shown in the diagram, the sharing AP may overhear an OBSS control frame exchange ((MU-)RTS frame and CTS frame exchange) between OBSS AP and OBSS STA in the P80 channel (which includes the primary channel) and perform NPCA channel switching (switch from operating in the primary channel to operating in the NPCA primary channel) based on overhearing the OBSS control frame exchange. The sharing AP may perform NPCA for a NPCA operation duration that is determined based on duration information included in the OBSS control frame exchange. The (MU-)RTS frame and CTS frame exchange may cause a NAV to be set.

Also, as shown in the diagram, the sharing AP may transmit (MU-)RTS TXS frame to the shared AP in the P80 channel (80 MHz bandwidth) to allocate a portion of its TXOP to the shared AP and the shared AP may respond by transmitting a CTS frame to the sharing AP in the P80 channel using a non-HT PPDU format. In this example, the Co-TDMA shared AP bandwidth (P80 channel) does not overlap with the NPCA available channel (S80 channel) so the issue of Problem 1 does not arise. However, in this example, the NPCA operation period ends after the portion of the TXOP allocated to the shared AP ends (e.g., the portion of the TXOP allocated to the shared AP has a duration of T time units and the NPCA operation duration has a duration of T+@ time units, where @ is a positive number). As a result, the sharing AP may not be able to receive a TXOP return frame from the shared AP (e.g., in the event that the shared AP finishes transmission and reception early and wishes to return the remaining portion of its allocated portion of the TXOP).

A third problem (referred to as Problem 3 herein) that can arise in a scenario where NPCA operations are performed in conjunction with Co-TDMA operations is that the NPCA operations may affect the sharing AP's ability to effectively use its allocated portion of the TXOP.

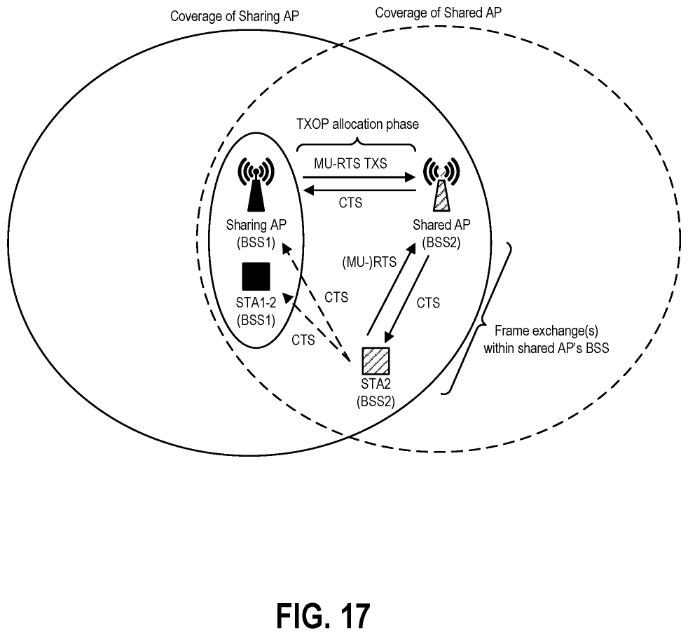

FIG. 17 is a diagram showing a wireless network in which NPCA operations and Co-TDMA operations can be performed in conjunction and when the shared AP's in-BSS transmission triggers NPCA, according to some embodiments.

As shown in the diagram, the wireless network includes a sharing AP operating a first BSS (BSS1) and a shared AP operating a second BSS (BSS2). BSS1 may include the following STA: STA1-2. BSS2 may include the following STA: STA2. In this example, it is assumed that the sharing AP and STA1-2 are capable of performing NPCA. Also, it is assumed that the sharing AP and the shared AP operate in the same primary channel. The coverage (transmission range) of the sharing AP is shown in a solid line and the coverage (transmission range) of the shared AP is shown in a dashed line.

To initiate Co-TDMA, the sharing AP and shared AP may perform a TXOP allocation phase via control frame exchange. For example, the sharing AP may transmit a MU-RTS TXS frame to the shared AP to allocate a portion of its TXOP to the shared AP and the shared AP may confirm this by transmitting a CTS frame to the sharing AP. Based on this allocation, the shared AP may be able to use the Co-TDMA shared AP bandwidth/channel for Co-TDMA (e.g., which may be the overlapping portion of the bandwidths/channels in which the MU-RTS TXS frame and CTS frame were transmitted). After being allocated a portion of the sharing AP's TXOP, the shared AP may perform a control frame exchange ((MU-)RTS frame and CTS frame exchange) with STA2. This control frame exchange may be considered by the sharing AP and STA1-2 as a transmission by an OBSS AP/STA. Thus, if this control frame exchange satisfies the NPCA triggering conditions, the sharing AP and STA1-2 may perform NPCA channel switching to perform NPCA.

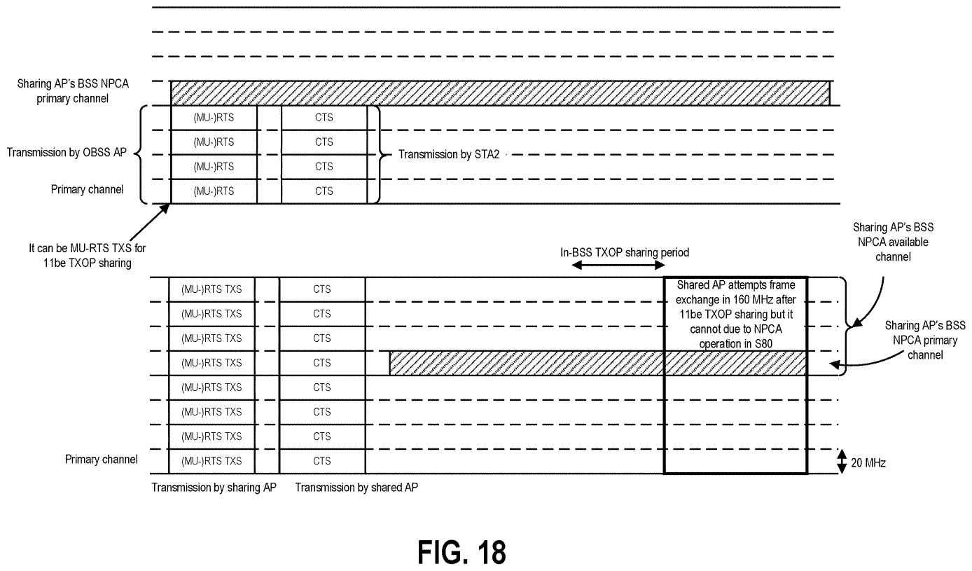

FIG. 18 is a diagram showing how the sharing AP's NPCA operations can interfere with the shared AP's in-BSS TXOP sharing, according to some embodiments.

In the situation described above, the sharing AP may transmit a (MU)-RTS TXS frame in a 160 MHz band, and the shared AP may respond by transmitting a CTS frame in the 160 MHz band using a non-HT PPDU format. Accordingly, the shared AP may use the 160 MHz band (which is the overlapping bandwidths of the (MU-)RTS TXS frame and the CTS frame exchange) during the portion of the sharing AP's TXOP allocated to the shared AP. That is, the Co-TDMA shared AP bandwidth is 160 MHz.

After being allocated a portion of the sharing AP's TXOP, the shared AP may initiate in-BSS TXOP sharing (e.g., IEEE 802.11be TXOP sharing) with STA2 in the P80 channel (80 MHz bandwidth) by transmitting (MU-)RTS frame to STA2 in the P80 channel. STA2 may respond by transmitting CTS frame in the P80 channel using a non-HT PPDU format.

The sharing AP and STA1-2 (which have NPCA capability) may satisfy the conditions for performing NPCA based on overhearing the control frame exchange between the shared AP and STA2 in the P80 channel. As such, the sharing AP and STA1-2 may perform NPCA channel switching to perform NPCA in the sharing AP's BSS NPCA primary channel (which is the S80 channel in this example). The situation shown in the diagram is a situation where the sharing AP (and STA1-2) attempt to perform NPCA channel switching based on overhearing a frame exchange ((MU)-RTS frame and CTS frame exchange) in the P80 channel (80 MHz bandwidth).

In terms of timing, it is assumed that the (MU)-RTS TXS frame and CTS frame exchange between the sharing AP and the shared AP (for Co-TDMA) may be followed by the (MU)-RTS frame and CTS frame exchange between the shared AP and STA2 (for in-BSS TXOP sharing). The (MU)-RTS frame and CTS frame exchange between the shared AP and STA2 may occur immediately after the (MU)-RTS TXS frame and CTS frame exchange between the sharing AP and the shared AP, or may occur after a certain amount of time. For example, if the shared AP has urgent downlink physical layer protocol data units (DL PPDUs) to transmit to its associated non-AP STAs, then the shared AP may transmit such DL PPDUs before transmitting the (MU)-RTS frame to STA2 for in-BSS TXOP sharing.

It is assumed in this example that the (MU)-RTS frame and CTS frame exchange between the shared AP and STA2 takes place after the control frame exchange between the sharing AP and the shared AP. Furthermore, it is assumed that the NPCA primary channel of the sharing AP's BSS overlaps with the Co-TDMA shared AP channel in which the (MU)-RTS TXS frame and CTS frame exchange took place (i.e., the channel in which the frame exchange of the shared AP's BSS may occur). In this case, the NPCA operation performed by the sharing AP and STA1-2 may prevent the shared AP from fully utilizing the Co-TDMA shared AP channel during the portion of the TXOP allocated to the shared AP via participation in Co-TDMA. This becomes more critical when the shared AP, after having shared the TXOP with STA2 (via in-BSS TXOP sharing), attempts to retrieve the TXOP and use the full 160 MHz bandwidth for the remaining duration.

In this situation, the shared AP cannot fully utilize the Co-TDMA shared AP bandwidth due to the NPCA operations of the sharing AP and STA1-2. For example, if the sharing AP succeeds in performing backoff in the NPCA primary channel and following the PIFS idle rule becomes able to use the entire NPCA available channel bandwidth, the Co-TDMA shared AP channel (the total 160 MHz bandwidth) may become unusable. That is, the channel in which the shared AP's BSS attempts a frame exchange overlaps with the NPCA available channel (in which the sharing AP and STA1-2 perform NPCA), making decoding impossible.

Also, if the frame exchange in the shared AP's BSS ends before the NPCA operation period ends in the sharing AP's BSS, and the shared AP attempts to transmit a TXOP return frame to the sharing AP to return the TXOP back to the sharing AP, the sharing AP will not be able to detect/decode the TXOP return frame due to performing NPCA.

A fourth problem (referred to as Problem 4 herein) that that can arise in a scenario where NPCA operations are performed in conjunction with Co-TDMA operations is that some of the STAs that are associated with the sharing AP may be hidden from the shared AP and not be able to ascertain the bandwidth in which the TXOP allocation occurs. STAs that are not in a hidden relationship with the shared AP are able to overhear the MU-RTS TXS frame and CTS frame exchange between the sharing AP and the shared AP. However, STAs that are in a hidden relationship with the shared AP may only be able to overhear the MU-RTS TXS frame transmitted by the sharing AP and not be able to overhear the subsequent CTS frame transmitted by the shared AP. In such a case, the hidden STAs may not be able to ascertain the full scope of the TXOP allocation. In particular, the hidden STAs may not be able to determine the Co-TDMA shared AP bandwidth/channel. This may prevent the hidden STAs from making an appropriate decision regarding whether NPCA operations will interfere with the Co-TDMA operations (e.g., prevent the hidden STA from being able to determine whether the NPCA available channel will overlap with the Co-TDMA shared AP channel). As a result, the hidden STAs may be unable to determine whether it is safe to initiate NPCA operations when they overhear an OBSS transmission.

The aforementioned problems may occur in a scenario where the sharing AP and the shared AP use the same primary channel, and after the sharing AP and shared AP perform a frame exchange for Co-TDMA (e.g., MU-RTS TXS frame and CTS frame exchange), NPCA-capable AP/STAs that belong to the sharing AP's BSS overhear OBSS transmissions and initiate NPCA operations. With Problem 1, NPCA operations may interfere with the shared AP's Co-TDMA operations. With Problem 2, the NPCA operation period may extend beyond the end of the TXOP, which may prevent the sharing AP from being able to receive a TXOP return frame. With Problem 3, NPCA operations triggered by frame exchanges in the shared AP's BSS may disrupt the shared AP's operations. With Problem 4, STAs that are in a hidden relationship with the shared AP cannot determine whether it is safe to perform NPCA operations.

A solution for addressing Problem 1 and Problem 3 is now described. In an embodiment, if the Co-TDMA shared AP channel overlaps with the NPCA available channel, NPCA operation is not performed. However, if there is no overlap, NPCA operations can be performed (assuming other conditions for performing NPCA are satisfied). By ensuring there is no overlap, it can be ensured that the NPCA operations will not interfere with the shared AP's BSS operations during the shared AP's allocated portion of the TXOP during Co-TDMA. In particular, an internal rule can be established that prevents NPCA-capable sharing APs and non-AP STAs that belong to the sharing AP's BSS from performing NPCA when the Co-TDMA shared AP channel overlaps with the sharing AP's BSS NPCA available channel.

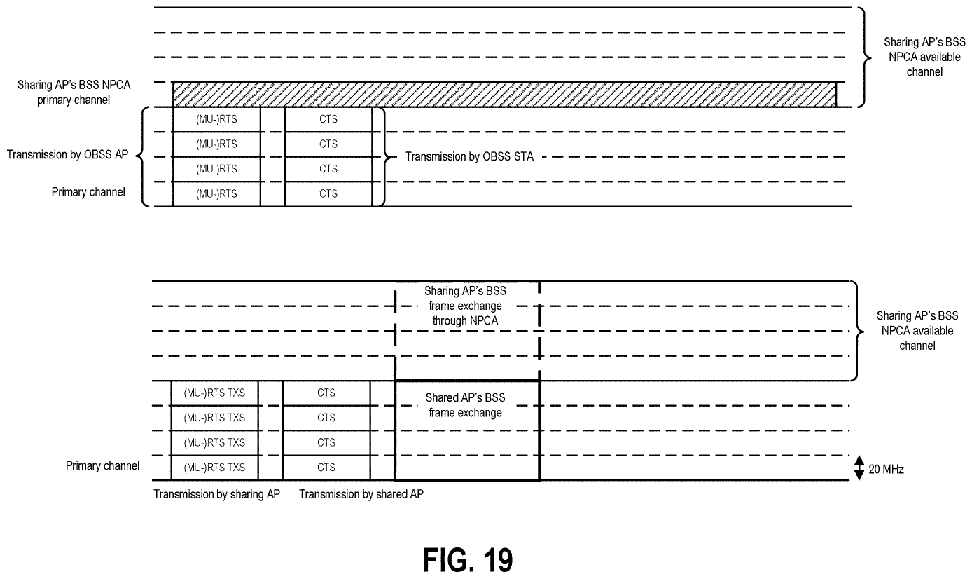

FIG. 19 is a diagram showing how NPCA can be performed when the NPCA available channel does not overlap with the Co-TDMA shared AP channel, according to some embodiments.

In the example shown in the diagram, it is assumed that the sharing AP transmits a (MU)-RTS TXS frame in the P80 channel (80 MHz bandwidth) to initiate Co-TDMA, and the shared AP responds by transmitting a CTS frame in the P80 channel using a non-HT PPDU format. Thus, the Co-TDMA shared AP bandwidth is 80 MHz (the P80 channel). Accordingly, the shared AP may use the P80 channel during the portion of the sharing AP's TXOP allocated to the shared AP. Also, in this example, it is assumed that an OBSS AP and an OBSS STA (from the perspective of the sharing AP's BSS) may exchange a (MU-)RTS frame and CTS frame in the P80 channel. Assuming that the OBSS AP and OBSS STA's frame exchange satisfies the conditions for performing NPCA channel switching, the sharing AP and its in-BSS STAs may perform NPCA channel switching to the NPCA primary channel and perform NPCA in the NPCA available channel (which is the S80 channel that includes the sharing AP's BSS NPCA primary channel). In this case, NPCA operation is allowed because the sharing AP's BSS NPCA available channel (S80 channel) does not overlap with the Co-TDMA shared AP channel (P80 channel), which ensures that the NPCA operations do not interfere with the shared AP's BSS frame exchanges during Co-TDMA.

A solution for addressing Problem 2 is now described. In an embodiment, the NPCA operation duration is adjusted based on the Co-TDMA end time to ensure that the NPCA operation period ends (e.g., any AP/STAs participating in NPCA return back to operating in the BSS primary channel) before the TXOP allocation period ends. This addresses the issue where the sharing AP and its in-BSS STAs delay returning back to operating in the BSS primary channel due to NPCA operations.

For example, NPCA-capable AP/STAs may switch to operating in the NPCA primary channel and transmit an initial control frame (ICF). One function of the initial control frame is to allow NPCA-capable AP/STAs to recognize which NPCA-capable AP/STAs have switched to operating in the NPCA primary channel. For example, the NPCA-capable AP may determine which NPCA-capable non-AP STAs have performed NPCA channel switching based on transmitting an initial control frame in the NPCA primary channel and observing which non-AP STAs have transmitted a response frame. The initial control frame may be a buffer status report poll (BSRP) frame or MU-RTS frame or similar frame. The initial control frame may include a special user info field (e.g., having an AID 12 value of 2008) that specifies a NPCA operation duration value that is configured such that the sharing AP and any associated STAs that perform NPCA return back to operating in the BSS primary channel before the portion of the TXOP allocated to the shared AP via Co-TDMA ends.

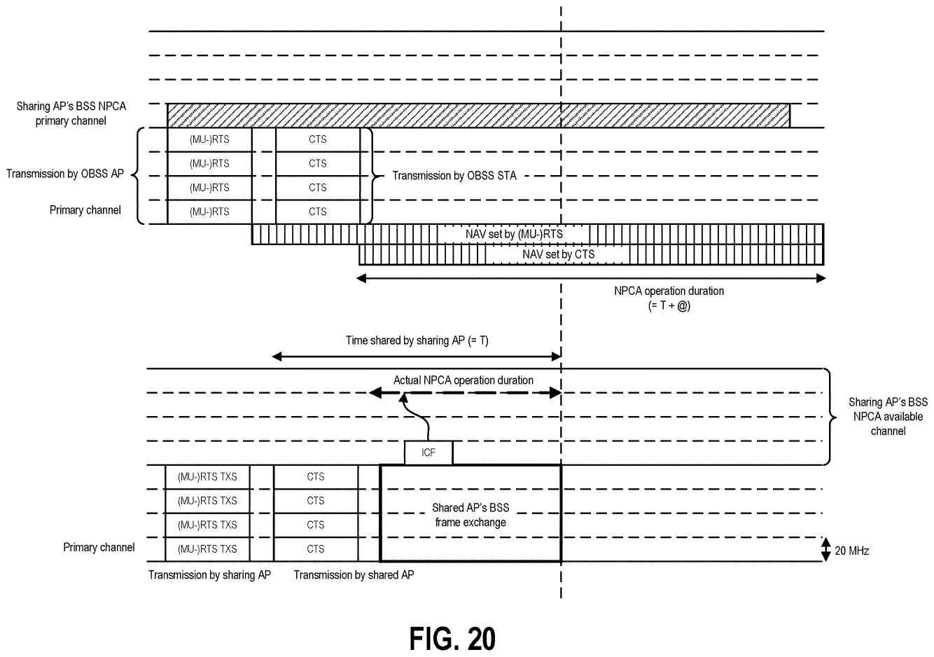

FIG. 20 is a diagram showing how the NPCA operation duration can be adjusted so that the NPCA operation period ends before the TXOP allocation period ends, according to some embodiments.

The NPCA-capable sharing AP and its in-BSS STAs may be in a situation where they can overhear an OBSS frame exchange between an OBSS AP and an OBSS STA ((MU-)RTS frame and CTS frame exchange) in the P80 channel, and perform NPCA channel switching to the sharing AP's BSS NPCA available channel (the S80 channel in this example). In this example, the NPCA operation duration (which may be determined based on the duration information included in the OBSS frame exchange) is assumed to be T+@ time units. Also, the sharing AP may allocate a portion of its TXOP to the shared AP via a control frame exchange ((MU-)RTS TXS frame and CTS frame exchange) in the P80 channel. In this case, the NPCA-capable sharing AP and its in-BSS STAs may shorten the NPCA operation duration from T+@ time units to T-# time units and transmit an initial control frame in the sharing AP's BSS NPCA primary channel indicating this shortened NPCA operation duration information. The T-# value may allow the actual NPCA operation duration to be shortened to ensure that the shared AP returns back to operating in the BSS primary channel before the shared AP's BSS frame exchange ends. This enables NPCA operations to be completed within the desired time frame so that the NPCA operations end at the same/similar time as the Co-TDMA operations.

A solution for addressing Problem 4 is now described. In an embodiment, non-AP STAs that are associated with the sharing AP and which are in a hidden relationship with the shared AP, determine whether to perform NPCA based on the sharing AP's actions after overhearing the MU-RTS TXS frame transmitted by the sharing AP. The actions of non-AP STAs that are in a hidden relationship with the shared AP can be controlled to prevent unnecessary NPCA operations.

NPCA-capable non-AP STAs that are associated with the sharing AP, which are in a hidden relationship with the shared AP, cannot directly perceive whether Co-TDMA operations are being performed. However, they can infer this based on the sharing AP's actions (or lack of action) after the sharing AP transmits a MU-RTS TXS frame or similar TXOP sharing frame. For example, after the sharing AP transmits a MU-RTS TXS frame to the shared AP to initiate Co-TDMA, the sharing AP will wait for the CTS frame response from the shared AP. If the CTS frame response does not arrive within the expected time (e.g., within a CTS timeout period), the sharing AP may infer that the MU-RTS TXS frame was lost or that the shared AP is not in a position to transmit a CTS frame. Accordingly, the sharing AP, as the original TXOP holder, may attempt to recover the medium after a PIFS interval after transmitting the MU-RTS TXS frame. If the medium is not lost, the sharing AP may retransmit the MU-RTS TXS frame to the shared AP (or another AP) or quit Co-TDMA operations altogether to perform other operations (e.g., transmit downlink traffic). Thus, if the non-AP STAs that are in a hidden relationship with the shared AP do not observe any further actions from the sharing AP for a period of time (e.g., for the CTS timeout period) after the sharing AP transmits the MU-RTS TXS frame, they may infer that the MU-RTS TXS frame and CTS frame exchange was successful for Co-TDMA. Thus, by overhearing the MU-RTS TXS frame and observing no further actions from the sharing AP for a period of time (e.g., the CTS timeout period plus some delta (i.e., slightly longer than the CTS timeout period)), they may recognize that NPCA operation is possible. The duration/length of the period of time that the hidden non-AP STAs wait for may depend on the implementation.

To perform NPCA operations without interfering with Co-TDMA operations, the NPCA primary channel should not overlap with the Co-TDMA shared AP channel (e.g., the NPCA primary channel and the channel in which the MU-RTS TXS frame and CTS frame exchange occurs should not overlap). Non-AP STAs that are in a hidden relationship with the shared AP cannot overhear the shared AP's CTS frame response but can recognize the maximum bandwidth that the CTS frame can be transmitted with based on the UL BW (uplink bandwidth) field or RU (resource unit) allocation field included in the MU-RTS TXS frame transmitted by the sharing AP. For example, if the MU-RTS TXS is transmitted with a UL BW field indicating a 80 MHz bandwidth, the non-AP STAs can check for overlap with the NPCA primary channel and decide whether to perform NPCA operation based on this. If no overlap occurs, the NPCA operation can be performed. Thus, in this case, the NPCA-capable STAs may switch to operating in the NPCA primary channel after overhearing the MU-RTS TXS frame and waiting for a period of time (the CTS timeout period) without overhearing a CTS frame response. The NPCA-capable STAs may then wait for the sharing AP's actions to confirm that the sharing AP has also switched to operating in the NPCA primary channel. The sharing AP's actions can be recognized through an initial control frame, which may include an indication of the NPCA operation duration. Upon receiving this initial control frame, the NPCA-capable STAs may perform frame exchanges in the NPCA available channel. If no further actions are observed from the sharing AP for a predefined time after performing NPCA channel switching (no initial control frame is received from the sharing AP), the NPCA-capable STAs can assume that the sharing AP has not moved to the NPCA primary channel and can switch back to operating in the BSS primary channel.

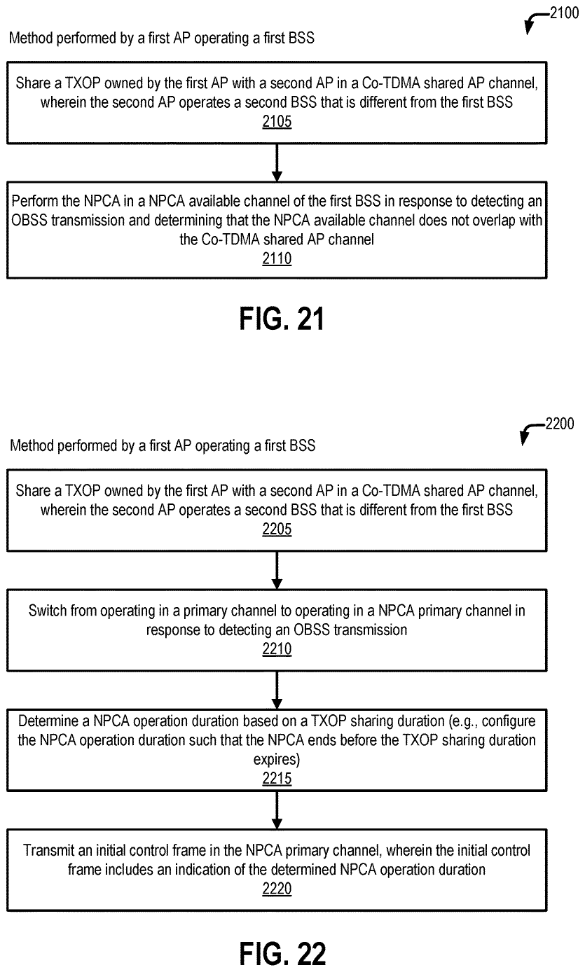

Turning now to FIG. 21, a method 2100 will be described for performing NPCA operations without interfering with Co-TDMA operations, in accordance with an example embodiment. The method 2100 may be performed by a first AP operating a first BSS. The first AP may be implemented by a wireless device (e.g., wireless device 104).

At operation 2105, the first AP shares a TXOP owned by the first AP with a second AP in a Co-TDMA shared AP channel, wherein the second AP operates a second BSS that is different from the first BSS.

At operation 2110, the first AP performs the NPCA in a NPCA available channel of the first BSS in response to detecting an OBSS transmission and determining that the NPCA available channel does not overlap with the Co-TDMA shared AP channel. In an embodiment, the OBSS transmission is a transmission by a third BSS that is different from the first BSS and the second BSS. In an embodiment, the OBSS transmission is a transmission by the second BSS.

In an embodiment, the first AP is configured not to perform NPCA if the NPCA available channel overlaps with the Co-TDMA shared AP channel.

In an embodiment, a non-AP STA can perform an operation similar to operation 2110 when deciding whether to perform NPCA channel switching. That is, the non-AP STA may determine whether to perform NPCA channel switching based on whether the NPCA available channel overlaps with the Co-TDMA shared AP channel.

Turning now to FIG. 22, a method 2200 will be described for configuring a NPCA operation duration, in accordance with an example embodiment. The method 2200 may be performed by a first AP operating a first BSS. The first AP may be implemented by a wireless device (e.g., wireless device 104).

At operation 2205, the first AP shares a TXOP owned by the first AP with a second AP in a Co-TDMA shared AP channel, wherein the second AP operates a second BSS that is different from the first BSS.

At operation 2210, the first AP switches from operating in a primary channel (of the first BSS) to operating in a NPCA primary channel (of the first BSS) in response to detecting an OBSS transmission.

At operation 2215, the first AP determines a NPCA operation duration based on a TXOP sharing duration. For example, the first AP may configure the NPCA operation duration such that an NPCA operation period ends before the TXOP sharing duration expires.

At operation 2220, the first AP transmits an initial control frame in the NPCA primary channel, wherein the initial control frame includes an indication of the determined NPCA operation duration. In an embodiment, the initial control frame includes a user information field that carries the indication of the determined NPCA operation duration.

In an embodiment the first AP performs aspects of the method shown in FIG. 21 and aspects of the method shown in FIG. 22. For example, the first AP may perform operation 2210 only if the condition of operation 2110 (the NPCA available channel of the first BSS does not overlap with the Co-TDMA shared AP channel) is satisfied.

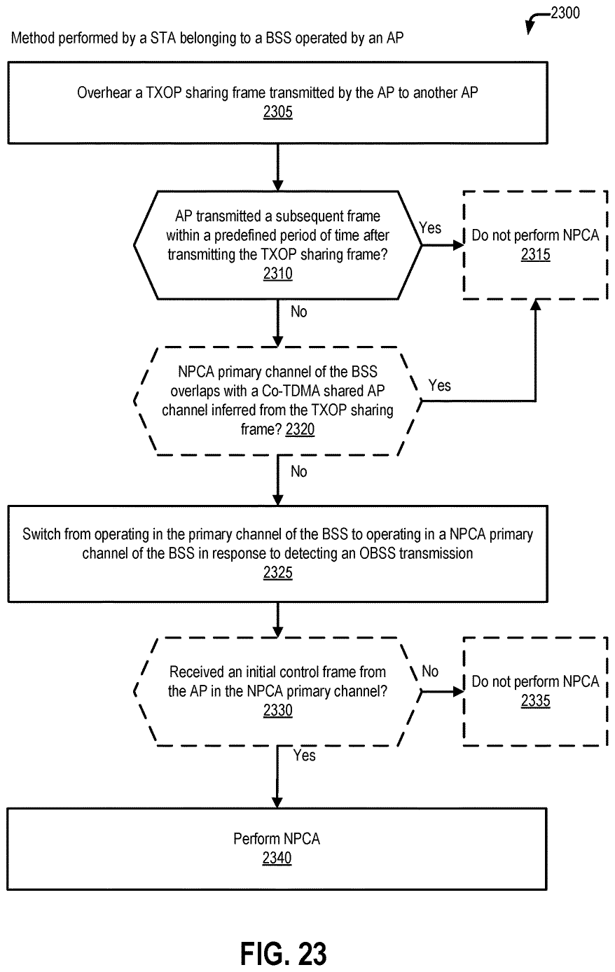

Turning now to FIG. 23, a method 2300 will be described for determining whether to perform NPCA channel switching, in accordance with an example embodiment. The method 2300 may be performed by a STA belonging to a BSS operated by an AP. The STA may be implemented by a wireless device (e.g., wireless device 104).

At operation 2305, the STA overhears a TXOP sharing frame transmitted by the AP to another AP. The STA may be in a hidden relationship with the another AP (and thus not able to overhear/decode transmissions by the another AP).

At operation 2310, the STA determines whether the AP transmitted a subsequent frame within a predefined period of time after transmitting the TXOP sharing frame. If the AP transmitted the subsequent frame within the predefined period of time, the method may proceed to operation 2315, at which the STA does not perform NPCA. Otherwise, if the AP did not transmit the subsequent frame within the predefined period of time, the method may proceed to operation 2320 (or directly to operation 2325). In an embodiment, the predefined period of time has a duration that corresponds to a CTS timeout period duration plus a delta (i.e., slightly longer than the CTS timeout period duration).

In an embodiment, at operation 2320, the STA determines whether a NPCA primary channel of the BSS overlaps with a Co-TDMA shared AP channel inferred from the TXOP sharing frame. If the NPCA primary channel overlaps with the inferred Co-TDMA shared AP channel, the method may proceed to operation 2315, at which the STA does not perform NPCA. Otherwise, if the NPCA primary channel does not overlap with the inferred Co-TDMA shared AP channel, the method may proceed to operation 2325. In an embodiment, the Co-TDMA shared AP channel is inferred based on a bandwidth indicated in an uplink bandwidth (UL BW) field included in the TXOP sharing frame.

At operation 2325, the STA switches from operating in the primary channel of the BSS to operating in a NPCA primary channel of the BSS in response to detecting an OBSS transmission.

In an embodiment, at operation 2330, the STA determines whether it received an initial control frame from the AP in the NPCA primary channel. If the STA did not receive an initial control frame, the method may move to operation 2335, at which the STA does not perform NPCA. Otherwise, if the STA received the initial control frame, the method may proceed to operation 2340, at which the STA proceed with performing NPCA. In an embodiment, the NPCA is performed for a duration corresponding to a NPCA operation duration indicated in the initial control frame.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a first access point (AP) operating a first basic service set (BSS) to perform non-primary channel access (NPCA) operations without interfering with coordinated time division multiple access (Co-TDMA) operations, the method comprising:
sharing a transmission opportunity (TXOP) owned by the first AP with a second AP in a Co-TDMA shared AP channel, wherein the second AP operates a second BSS that is different from the first BSS; and
performing NPCA in a NPCA available channel of the first BSS in response to detecting an overlapping basic service set (OBSS) transmission and determining that the NPCA available channel does not overlap with the Co-TDMA shared AP channel.

2. The method of claim 1, wherein the OBSS transmission is a transmission by a third BSS that is different from the first BSS and the second BSS.

3. The method of claim 1, wherein the OBSS transmission is a transmission by the second BSS.

4. The method of claim 1, wherein the first AP is configured not to perform NPCA if the NPCA available channel overlaps with the Co-TDMA shared AP channel.

5. The method of claim 1, further comprising:
determining a TXOP sharing duration;
determining a NPCA operation duration based on the TXOP sharing duration; and
transmitting an initial control frame in a NPCA primary channel, wherein the initial control frame includes an indication of the NPCA operation duration.

6. The method of claim 5, wherein the NPCA operation duration is configured such that the NPCA ends before the TXOP sharing duration expires.

7. The method of claim 5, wherein the initial control frame includes a user information field that carries the indication of the NPCA operation duration.

8. A method performed by a station (STA) belonging to a basic service set (BSS) operated by an access point (AP) to perform non-primary channel access (NPCA) during coordinated time division multiple access (Co-TDMA), the method comprising:
overhearing a transmission opportunity (TXOP) sharing frame transmitted by the AP to another AP;
determining whether the AP transmitted a subsequent frame within a predefined period of time after transmitting the TXOP sharing frame; and
performing the NPCA in a NPCA available channel of the BSS in response to detecting an overlapping basic service set (OBSS) transmission and determining that the AP has not transmitted the subsequent frame within the predefined period of time.

9. The method of claim 8, wherein the predefined period of time has a duration that corresponds to a clear-to-send (CTS) timeout period duration plus a delta.

10. The method of claim 8, wherein the STA is configured not to perform NPCA if the STA determines that the AP did transmit the subsequent frame within the predefined period of time.

11. The method of claim 8, further comprising:
determining whether a NPCA primary channel of the BSS overlaps with a Co-TDMA shared AP channel inferred from the TXOP sharing frame, wherein the NPCA is performed further in response to determining that the NPCA primary channel does not overlap with the inferred Co-TDMA shared AP channel.

12. The method of claim 11, wherein the Co-TDMA shared AP channel is inferred based on a bandwidth indicated in an uplink bandwidth field included in the TXOP sharing frame.

13. The method of claim 8, further comprising:
receiving an initial control frame from the AP in a NPCA primary channel, wherein the NPCA is performed further in response to receiving the initial control frame.

14. The method of claim 13, wherein the NPCA is performed for a duration corresponding to a NPCA operation duration indicated in the initial control frame.

15. The method of claim 8, wherein the STA is in a hidden relationship with the another AP.

16. A wireless device configured to implement a first access point (AP) operating a first basic service set (BSS), the wireless comprising:
a radio frequency transceiver;
a memory device storing a set of instructions; and
a processor coupled to the memory device, wherein the set of instructions, when executed by the processor, causes the first AP to:
share a transmission opportunity (TXOP) owned by the first AP with a second AP in a coordinated time division multiple access (Co-TDMA) shared AP channel, wherein the second AP operates a second BSS that is different from the first BSS; and
perform non-primary channel access (NPCA) in a NPCA available channel of the first BSS in response to detecting an overlapping basic service set (OBSS) transmission and determining that the NPCA available channel does not overlap with the Co-TDMA shared AP channel.

17. The wireless device of claim 16, wherein the instructions, when executed by the processor, further causes the first AP to:
determine a TXOP sharing duration;
determine a NPCA operation duration based on the TXOP sharing duration; and
transmit an initial control frame in a NPCA primary channel, wherein the initial control frame includes an indication of the NPCA operation duration.

18. The wireless device of claim 17, wherein the NPCA operation duration is configured such that the NPCA ends before the TXOP sharing duration expires.

19. A wireless device configured to implement a station (STA) belonging to a basic service set (BSS) operated by an access point (AP), the wireless comprising:
a radio frequency transceiver;
a memory device storing a set of instructions; and
a processor coupled to the memory device, wherein the set of instructions, when executed by the processor, causes the STA to:
overhear a transmission opportunity (TXOP) sharing frame transmitted by the AP to another AP;
determine whether the AP transmitted a subsequent frame within a predefined period of time after transmitting the TXOP sharing frame; and
perform non-primary channel access (NPCA) in a NPCA available channel of the BSS in response to detecting an overlapping basic service set (OBSS) transmission and determining that the AP has not transmitted the subsequent frame within the predefined period of time.

20. The wireless device of claim 19, wherein the predefined period of time has a duration that corresponds to a clear-to-send (CTS) timeout period duration plus a delta.
